(19) United States
(12) Patent Application Publication
(10) Pub. No.: US 2004/0184722 A1
(43) Pub. Date: Sep. 23, 2004

(54) Device and method for broadband transmission of digital optical signals between traveling units

(76) Inventor: Harry Schilling, Eichstatt (DE)

Correspondence Address: CONLEY ROSE, P.C., P.O. BOX 684908, AUSTIN, TX, 78768, US

(21) Appl. No.: 10/736,446

(22) Filed: Dec. 15, 2003

(30) Foreign Application Priority Data
Dec. 20, 2002 (DE) 10260940.3

(51) Int. Cl. G02B 6/26

(52) U.S. Cl. 385/25

(57) ABSTRACT

A device for transmitting digital optical signals between two units traveling relative to each other comprises a controller located on a transmitter side for controlling an issued data rate or package size of the digital signals, so that an optimum transmission is achieved by an adaptation to the transmission characteristics of a transmission path. An optional evaluation means located on a receiver side restores original signals so that a conversion remains concealed, but a substantially more reliable transmission is achieved.

### FIELD OF THE INVENTION

The invention relates to a device for optical transmission of digital signals between a plurality of units traveling relative to each other.

For the sake of overall clarity no distinction is made in this document between a transmission between units traveling relative to each other, and between one fixed unit and units traveling relative thereto, because this is only a question of positional reference and does not affect the manner of operation of the invention. In the same way, no distinction is made between a transmission of signals and energy, because here the working mechanisms are the same.

### DESCRIPTION OF THE PRIOR ART

With linearly traveling units, such as crane and conveyor systems, and also with rotating units such as radar installations or even computer tomographs, it is of special advantage to transmit information optically. For this, in most cases an optical waveguide is provided in a first unit, and a corresponding coupling element in a second unit. In the following expositions the term optical waveguide relates to all conceivable kinds of optical guides or optical waveguides which are suitable for conducting optical signals. Waveguides of this kind and corresponding coupling-in mechanisms are described, for example in DE 195 02 989 A1 (fluorescent material), WO 98/00936 (optical waveguide operated as a laser), DE 1 002 256 (optical waveguide with signal coupling-in by means of a dynamic grid), or in U.S. Pat. No. 6,453,088 B1 (reflecting trench).

All of the above-mentioned optical systems require small mechanical tolerances. Particularly with large units such as computer tomographs having a diameter of an order of magnitude of 1.5 meters, tolerances of the order of magnitude of 0.1 mm between a rotating and a stationary part can no longer be achieved. With larger mechanical tolerances a damping of the coupling increases, i.e. less light is coupled from a transmitter into a receiver. Because of this, a signal-to-noise difference is also reduced. Thus, for a same data rate, a bit-error rate is higher, or for a same bit-error rate, only a lower data rate can be achieved.

### BRIEF SUMMARY OF THE INVENTION

Thus, an object arises of providing a device and a method for an optical transmission of signals, with which the above disadvantages are avoided and, in particular, a maximum of use is made of a transmission channel, so that a high transmission quality of signals over a large bandwidth is achieved.

A device in accordance with the invention serves to transmit digital signals between at least two units traveling relative to each other. Of course, one or a plurality of units may be disposed on each side of the travel. In order to simplify the illustration, reference is here made exclusively to a second unit which is adapted to travel relative to a first unit.

In the following the invention is described by way of example, without limitation of the general inventive concept, by means of examples of embodiment with reference to the drawings.

### BRIEF DESCRIPTION OF THE DRAWING

FIG. 1 schematically shows in a general form a device according to the invention.

### DETAILED DESCRIPTION OF THE PREFERRED EMBODIMENTS

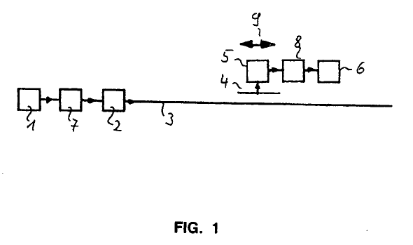

In FIG. 1 a particularly advantageous embodiment of a device according to the invention is schematically illustrated. The data of a source 1 are transmitted to an optical waveguide 3 via a controller 7 and an optical transmitter 2. The waveguide is disposed along a track of travel indicated by the directional arrow 9, and guides the signals fed in by the transmitter. A coupling element 4 enables a tapping of the signals in a short-range field of a transmitter conductor-structure. The signals tapped by the coupling element are guided via an optical receiver 5 and an evaluation means 8 to a data sink 6.

To the first unit is assigned the data source 1 for generating a serial stream of data, such as, for example, a prior art parallel-serial converter. Furthermore, the optical transmitter 2 is provided for producing optical signals from the serial data stream of the data source 1, for transmission via the optical waveguide 3. To the second unit is assigned the optical coupling element 4 for tapping optical signals from the optical waveguide. The optical signals 5 of the optical coupling element 4 are supplied via the optical receiver 5 to the data sink 6 for further processing of the signals.

Now, according to the invention the controller 7 is provided which selectively controls the data source 1 or the optical transmitter 2 to issue a predetermined data rate or package size in accordance with a desired value. Optionally also, the controller may be disposed between the data source 1 and the optical transmitter 2, and designed in such manner that it by itself formats and converts the data. data rate or package size issued by the data source 1 in accordance with a desired value. Thus the issuing of the data can be adapted to the currently prevailing properties of a data path.

The essential feature of the controller is its adapting of the coding of any digital signal to the transmission characteristics of the optical data path between the optical transmitter and the optical receiver.

By means of a device according to the invention, a substantially better quality of signal transmission can be achieved than in prior art.

Optionally a decoding means for converting the data rate or package size to the data rate or package size issued by the data source 1 can additionally be provided in the second unit between the optical receiver 5 and the data sink 6.

By means of this decoding means, an encoding made at the first unit is cancelled, so that the signals passed to the data sink correspond to the data stream of the data source 1. Of course, the decoding means may also be disposed in the receiver 5. Thus, an encoding made for an optimum transfer of the data along the data path becomes completely transparent for the data source or data sink.

Particularly with units traveling relative to each other, the actual data rate to be transmitted frequently varies with time or position. Parameters of influence are for example, the distance between the two units traveling relative to each other, the coupling between these units, or also external interference effects. With the aid of the encoding means, the data rate is continuously conformed. If, for example, at a particular point in time or at a particular position a transmission is possible only with a relatively low data rate, the data of the data sources are intermediately stored in memory means. Now if the possible data rate of the data path is again increased owing to a passing of time or a change of position, then the intermediately stored information can be transmitted. The decoding means is designed in accordance with this, and also has means for storing data in the case of a high data rate from the encoding means, and therefore can ensure a continuous data stream to the data sink. For optimum control, optional means can be provided for measuring the transmission characteristics.

In most cases, generic transmission systems are provided with a transmission path which is closed along the track of the travel of the two units. A closed transmission path is present when the optical waveguide 3 is in engagement with the coupling element 4, so that data can be transmitted. As an alternative to this, the transmission path may also be segmented. i.e. consist of several parts. In an extreme case the transmission path could consist of one single segment which is provided at a particular position. In this case, control is performed by the controller in such manner that transmission takes place exclusively at the positions where segments of the transmission path are available.

In another embodiment of the invention, the controller is designed to have means for storing data. Hereby it becomes possible to conform the data rate or segmentation to different package sizes without loss of data.

In a further advantageous embodiment of the invention, a desired-value setting-means is provided for setting the desired value and optionally adapting the setting of the desired value dynamically during operation of the device according to the characteristics of the transmission path, such as, for example, the transmission quality, bit error rate, and signal-to-noise difference, or simply on the basis of the position of the two traveling units relative to each other, or of time.

In another advantageous embodiment of the invention the encoding means has additional memory means as well as means for adapting the data rate of the serial data stream to be transmitted. Thus, the data rate can be conformed in accordance with the actual transmission characteristics of the transmission path between transmitter and receiver.

In a further advantageous embodiment of the invention, the controller has additional means for storing the data. Furthermore, an auxiliary communication channel is provided between an evaluation means additionally disposed between the optical receiver 5 and the data sink 6, and the controller, for incorrect data to be signaled by the evaluation means to the controller. Now, if the evaluation means detects incorrectly transmitted data, it signals this to the controller which thereupon reissues the data. Such mechanisms are basically known for signal transmission at higher levels. Thus, in these cases a communication takes place between a first computer which is connected to the data sources, and a second computer which is connected to the data sink. For this, the communication and the repeating of the data transmission requires additional computing capacity. Because of the integration at a low level of data transmission, the repetition of the transmission takes place independently from the transmission protocol and independently from additional operations of the communicating computers. Thus, the device according to the invention can be operated independently from the computer systems connected thereto. At the same time it ensures a maximum flexibility and reliability of transmission at minimum additional load on the connected computers.

In a further advantageous development of the invention, at least one micro controller is provided for control or diagnosis of the device. The micro controller optionally has a memory for storing particular events such as errors, or also an exceeding of limiting values. Advantageously such a micro controller has a web server, so that it can be operated locally by means of a conventional personal computer or an internet terminal, or via the internet. Furthermore, optionally a display of certain operating conditions or operating parameters is provided. Thus, for example, transmission errors, signal-to-noise difference, bit error rate or the exceeding of certain limiting values can be displayed. Optionally, the entire control may be newly configured using software. Thus, for example, memory contents, data tables or even program codes may be newly loaded as required.

In a further advantageous development the device is designed to be self-learning or adaptive. This means that it dynamically adapts to the operating conditions, in particular during travel. This can be achieved, for example, by determining certain operating parameters such as bit error rate, signal amplitude etc., and subsequently setting the controller or the evaluation means or the filters. Here it is therefore particularly advantageous to use a fuzzy controller. Thus, for example, the redundancy or the data rate can be set as a function of the transmission errors. This means that for a large number of transmission errors, for example a higher redundancy is provided. Especially for rotary movements, in particular at constant speed, it is of advantage to store the transmission function in terms of a rotation and, in correspondence therewith, to perform the setting of the controller or the evaluation means or the filters in dependence upon time or the position. This, of course, is possible also for linear movements inasmuch as information is available concerning the position.

A method in accordance with the invention serves for broadband signal transmission on a device as described. In the method the data rate, or the size of the data packages to be transmitted, is adapted in dependence upon a desired value. The desired value is preferably formed from parameters which are representative of the actual transmission characteristics of the data path or other characteristics of the data path, such as position, time etc.

List of Reference Numerals

1 data source

2 optical transmitter

3 optical waveguide

4 optical coupling element

5 optical receiver

6 data sink

7 controller

8 evaluation means

9 directional arrow for direction of travel

1. Device for broadband transmission of digital optical signals between at least one first unit and at least one second unit traveling relative to the first unit along a given track, the device comprising, in association with the first unit:
a data source for generating a serial data stream;
an optical transmitter for generating optical signals from the serial data stream of the data source;
an optical waveguide for guiding the optical signals generated by the optical transmitter;
and also comprising, in association with the second unit:
a coupling element for tapping optical signals from the optical waveguide;
an optical receiver for receiving the signals tapped by the coupling element;
a data sink for further processing the signals received by the optical receiver;
wherein a controller is provided for controlling the data stream, the controller signaling, by means of a desired value, a predetermined data rate or package size selectively either to the data source or to the optical transmitter:

2. Device for broadband transmission of digital optical signals between at least one first unit and at least one second unit traveling relative to the first unit along a given track, the device comprising, in association with the first unit:
a data source for generating a serial data stream;
an optical transmitter for generating optical signals from the serial data stream of the data source;
an optical waveguide for guiding the optical signals generated by the optical transmitter;
and also comprising, in association with the second unit:
a coupling element for tapping optical signals from the optical waveguide;
an optical receiver for receiving the signals tapped by the coupling element;
a data sink for further processing the signals received by the optical receiver;
wherein a controller is provided for controlling the data stream, the controller being disposed between the data source and the optical transmitter and converting the data of the data source in accordance with a desired value to a predetermined data rate or to packages of predetermined package size.

3. Device according to claim 2, wherein the controller comprises means for storing data, and also for issuing stored data at different data rates to the transmitter.

4. Device according to claim 1 or 2, wherein the desired value is set by a desired-value setting-means according to the actually prevailing transmission characteristics of the data path between the optical transmitter and the optical receiver, or according to another measured parameter.

5. Device according to claim 1 or 2, wherein
an evaluation means is provided between the optical receiver and the data sink;
the evaluation means has additional means for signaling incorrectly transmitted data to the controller by means of an auxiliary transmission channel; and
the controller is adapted to repeat a transmission of incorrectly received data packages upon request by the evaluation means.

6. Device according to claim 1 or 2,
wherein a microcontroller is provided for control and diagnosis of the device.

7. Device according to claim 1 or 2,
wherein the device is self-learning and during operation dynamically adapts to currently prevailing operating conditions.

8. Method for broadband transmission of digital signals between at least one first unit and at least one second unit traveling relative to the first unit along a given track, the method comprising the steps of:
generating from a data source at the first unit a serial data stream;
generating optical signals from the serial data stream of the data source with an optical transmitter at the first unit;
guiding the optical signals generated with the optical transmitter along an optical waveguide;
tapping optical signals from the optical waveguide with a coupling element at the second unit;
receiving the optical signals tapped with the coupling element with an optical receiver at the second unit;
further processing the signals received by the optical receiver at a data sink at the second unit;
wherein the method comprises the following further steps, performed dynamically during operation:
determining at least one parameter which is representative of actually prevailing transmission characteristics of a data path between the transmitter and the receiver;
forming a desired value of a data rate or data package size from the determined at least one parameter;
setting a data rate or a size of data packages for transmission along the data path in accordance with the desired value;
transmitting a data stream at the set data rate or size of data packages along the data path to the receiver.
